(19) United States
(12) Patent Application Publication
(10) Pub. No.: US 2022/0113866 A1
(43) Pub. Date: Apr. 14, 2022

(54) LADDER OF REMOTE ACCESS

(71) Applicant: Cynthia Vargas, San Antonio, TX (US)

(72) Inventor: Cynthia Vargas, San Antonio, TX (US)

(21) Appl. No.: 17/498,717

(22) Filed: Oct. 11, 2021

Related U.S. Application Data
(60) Provisional application No. 63/089,763, filed on Oct. 9, 2020.

(51) Int. Cl. G06F 3/04886; G06F 3/041; G06F 3/14

(52) U.S. Cl. CPC G06F 3/04886; G06F 3/14; G06F 3/0416

(57) ABSTRACT

Disclosed herein are systems and methods for a tablet based task management system directed to parents and children. In an embodiment, there is a parent tablet and child tablet. The parent tablet allows for communication, task assignment, management and monitoring with the child tablet. The child tablet allows for communication, tasks, progress reporting and updates with the parent tablet. The child tablet system is customizable to the child to accommodate for the child's age, learning level and any disabilities. The LORA aims to simplify and streamline management of tasks, schedules, and appointments of parents and children,

### CROSS-REFERENCE TO RELATED APPLICATIONS

This application claims the benefit under Title 35 United States Code § 119(e) of U.S. Provisional Patent Application Ser. No. 63/089,763; Filed: Oct. 9, 2020, the full disclosure of which is incorporated herein by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to systems and methods for a tablet based task management system. More specifically, the present invention generally relates to systems and methods for a tablet based task management system for use between parents and children to manage daily tasks, chores and appointments.

### BACKGROUND OF THE INVENTION

Without limiting the scope of the disclosed systems and methods, the background is described in connection with novel systems and methods for a tablet based task management system directed to parents and children.

In response to increasingly busy lives of parents and children, attempting to manage schedules, appointments, calendars, and household chores of each child has become increasingly more difficult and time consuming. Further, it can be difficult for children to prioritize tasks and chores and they can easily forget what it is they were asked to do.

Physical calendars and chore charts can be time consuming to maintain and may not be a successful option depending on the child's age, learning level, or if the child has any disability. Cell phones provide communications between parents and children but are not ideal for keeping track of tasks and are not as user friendly or practical for all children.

The Ladder or Remote Access or “LORA” as abbreviated herein, provides a customizable tablet based system that provides an efficient means of communication and task management between parents and children.

The present invention therefore proposes a novel systems and methods for a tablet based task management system.

### BRIEF SUMMARY OF THE INVENTION

The LORA system in an embodiment, is comprised of: at least one parental tablet and at least one child tablet.

The parent tablet in an embodiment will be larger than the child tablet. The parent tablet will be able to easily communicate with the child tablet utilizing text, voice and video. The parent tablet will also be able to accommodate for sign language communications. Additionally it will include social skills cues such as: please; hello; thank you; I need help; my name is; etc. In an embodiment the parent tablet will have capabilities such as creating, monitoring and managing: task lists; grocery lists; calendar; pictorials; task cards; schedules; and appointments.

The parent tablet will also contain such features as an alarm, timer, camera, light, GPS, SOS, night monitor with motion sensor, voice activation and a two-way speaker. The parent tablet will also include a volume and power controls, headphone capabilities, HDMI port, synching capabilities, and charging function.

The child tablet, in an embodiment will be smaller than the parent tablet. The child tablet will provide easily accessible communication options to the parent tablet. The child tablet will have the same communication capabilities such as text, voice, video, means for sign language communications and contain social skills cues. In an embodiment the child tablet will have capabilities such as viewing task lists, viewing pictorials, viewing task cards, viewing schedules, and appointment reminders.

The child tablet will have similar features to the parent tablet such as alarm, timer, camera, light, GPS, SOS, night monitor with motion sensor, voice activation and a two-way speaker. The child tablet will also include a volume and power controls, headphone capabilities, HDMI port, synching capabilities, and charging function.

The parent tablet will assign and schedule tasks to the child tablet. Such tasks could include household chores, and homework. The parent tablet will be able to monitor the progress of the assigned tasks while maintaining a line of communication between the parent and child. The child pad will receive the tasks and reminders to complete the tasks throughout the day. Once a task is complete, the user of the child pad will report a task finished and the parent tablet will be notified as such.

There will be multiple interfaces available on the child tablet, customizable to the needs and age of the child. For example a younger child may require pictorials to denote a task rather than a word-based task format.

The parent tablet will have the capability to communicate and manage more than one child tablet simultaneously. Each child tablet will remain fully customizable to the individual child when there are multiple child tablets in communication with one parent tablet. Additionally, there may be more than one parent tablet capable of communicating and managing any given child tablet.

In summary, the present invention generally relates to systems and methods for a tablet based task management system. More specifically, the present invention relates to systems and methods a tablet based task management system between a parent and child.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a right side perspective view of the parent tablet in accordance with embodiments of the disclosure;

FIG. 2 is a left side perspective view of the parent tablet in accordance with embodiments of the present disclosure;

FIG. 3 is a top side view of the parent tablet in accordance with embodiments of the disclosure;

FIG. 4 is a bottom side view of the parent tablet in accordance with embodiments of the present disclosure;

FIG. 5 is a front view of the parent tablet in accordance with embodiments of the present disclosure;

FIG. 6 is a back side view of the parent tablet in accordance with embodiments of the present disclosure;

FIG. 7 is a perspective view of the child tablet in accordance with embodiments if the present disclosure;

FIG. 8 is a screenshot of the parent tablet assignments interface in accordance with embodiments of the disclosure;

FIG. 9 is a child tablet interface in accordance with embodiments of the disclosure;

FIG. 10 is an alternate child tablet interface in accordance with embodiments of the disclosure;

FIG. 11 is a child tablet pictorial interface in accordance with embodiments of the disclosure;

FIG. 12 is a parent tablet interface in accordance with embodiments of the disclosure.

### DETAILED DESCRIPTION OF THE INVENTION

Disclosed herein is systems and methods for a tablet based task management system between a parent and child.

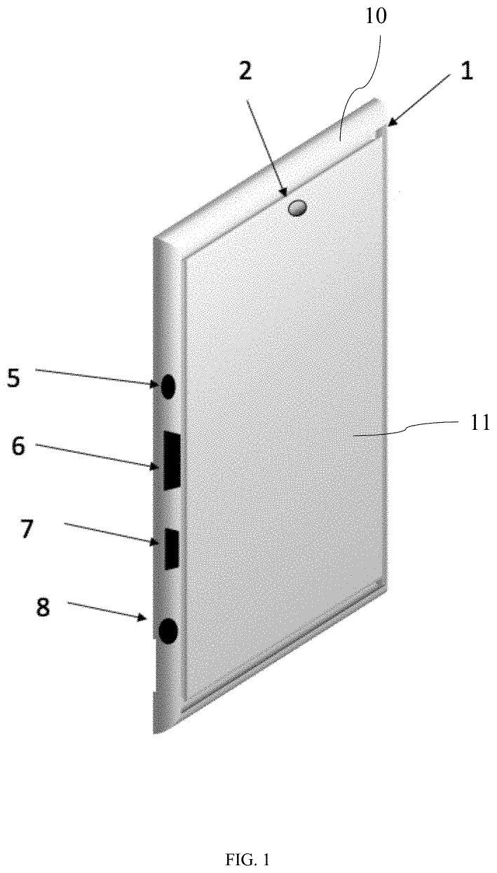

Reference is first made to FIG. 1, a right side perspective view of the parent tablet in accordance with embodiments of the disclosure. In one embodiment the device is comprised of a tablet body 10, and large tablet screen 11 encompassing most of the front facing body. Around the screen is a front light 1, a front camera 2, a headphone jack 5, a HDMI port 6, a synching port 7, and a charging port 8.

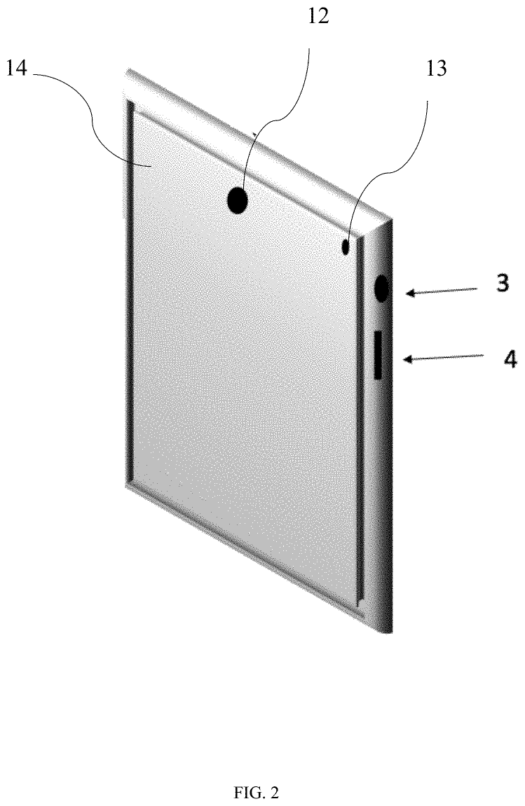

Reference is next made to FIG. 2, a left side perspective view of the parent tablet in accordance with embodiments of the present disclosure. The back side of the tablet body 14 also contains a back camera 12, and a back light 13. On the left side body of the tablet is a power button 3, and volume control 4.

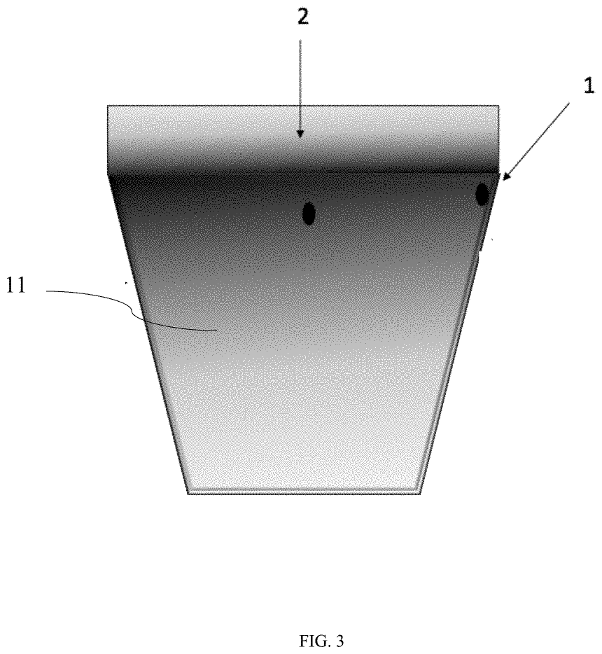

Reference is now made to FIG. 3 is a top side view of the parent tablet in accordance with embodiments of the disclosure. Above the tablet screen 11 is a front camera 2 and front light 1.

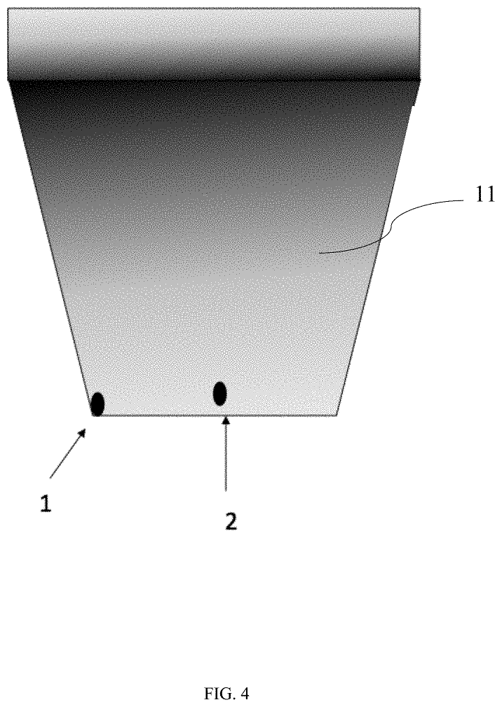

Reference is next made to FIG. 4 is a bottom side view of the parent tablet in accordance with embodiments of the present disclosure.

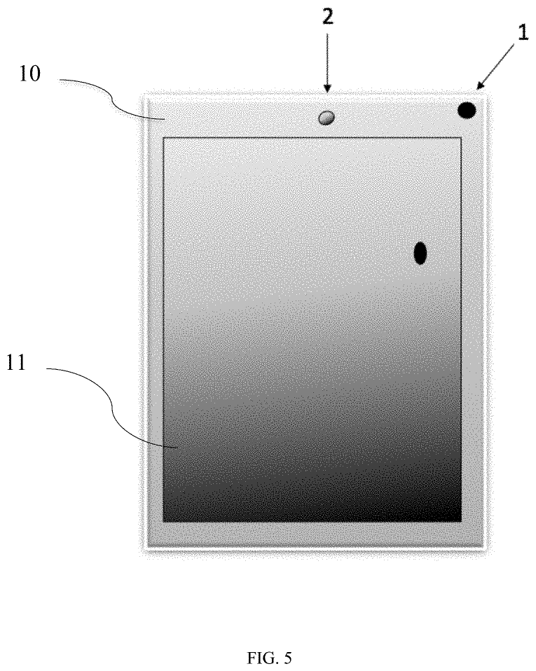

Reference is now made to FIG. 5 is a front view of the parent tablet in accordance with embodiments of the present disclosure. The tablet screen 11 encompasses most of the front side of the tablet body 10. The front camera 2 and front light 1 are positioned on tablet body 10, above the tablet screen 11.

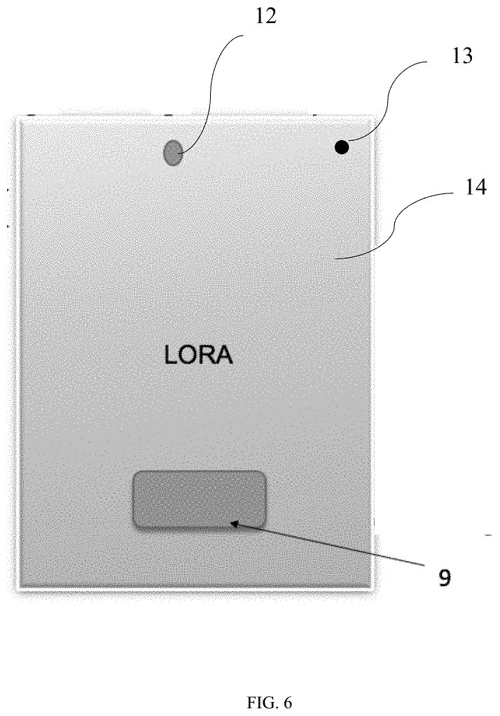

Reference is next made to FIG. 6 is a back side view of the parent tablet in accordance with embodiments of the present disclosure. The back body of the tablet 14 contain a back camera 12, back light 13 and speaker 9.

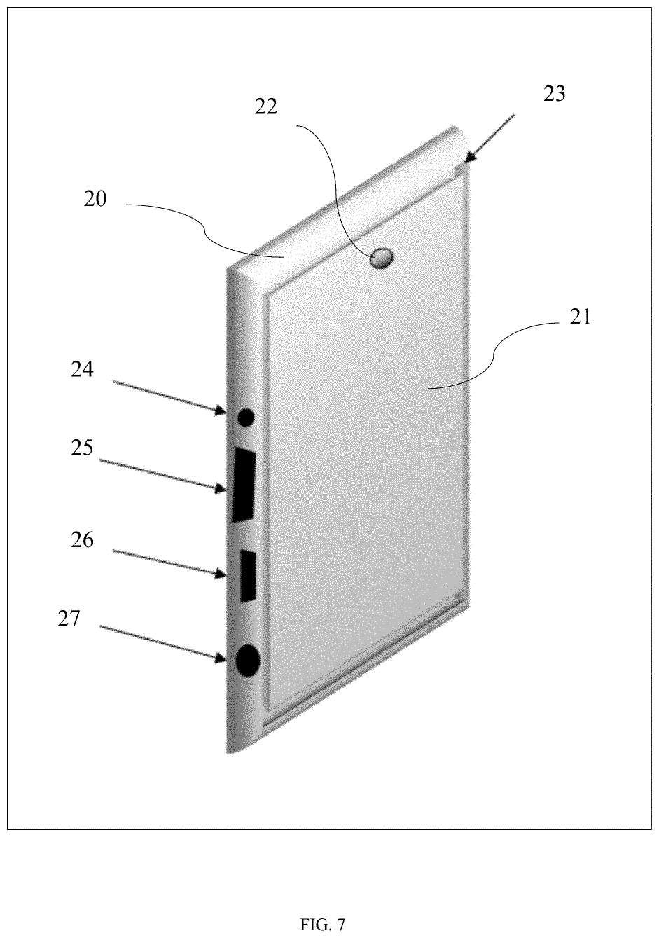

Reference is now made to FIG. 7 is a perspective view of the child tablet in accordance with embodiments of the present disclosure. The child tablet contains all the same elements as the parent tablet, in a smaller size. The tablet body 20 houses a front camera 22 and front light 23. There is also a headphone jack 24, a HDMI port 25, a synching port 26, and a charging port 27.

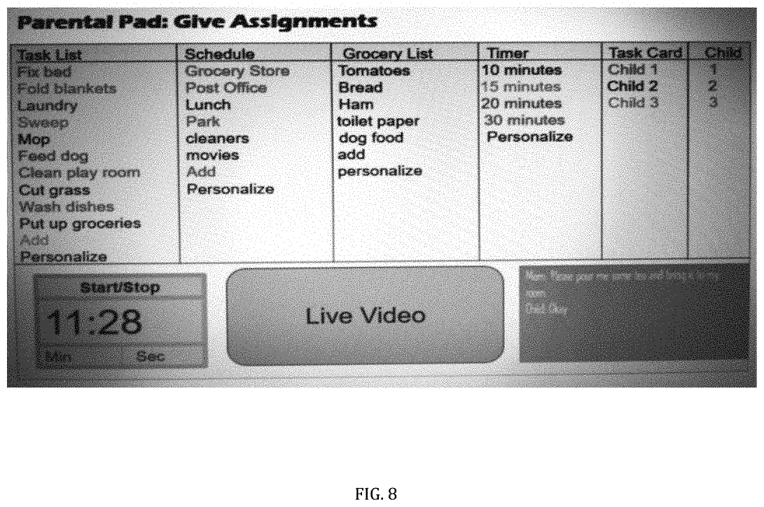

Reference is next made to FIG. 8 is a screenshot of the parent tablet assignments interface in accordance with embodiments of the disclosure.

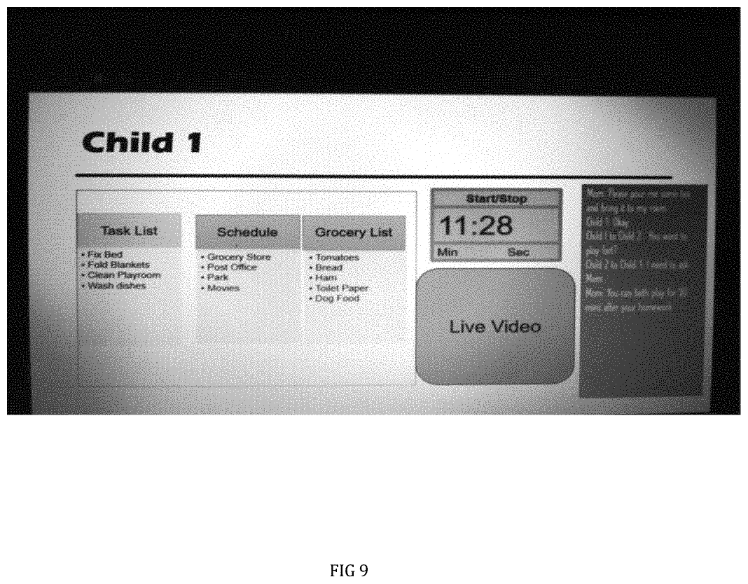

Reference is now made to FIG. 9 is a child tablet interface in accordance with embodiments of the disclosure.

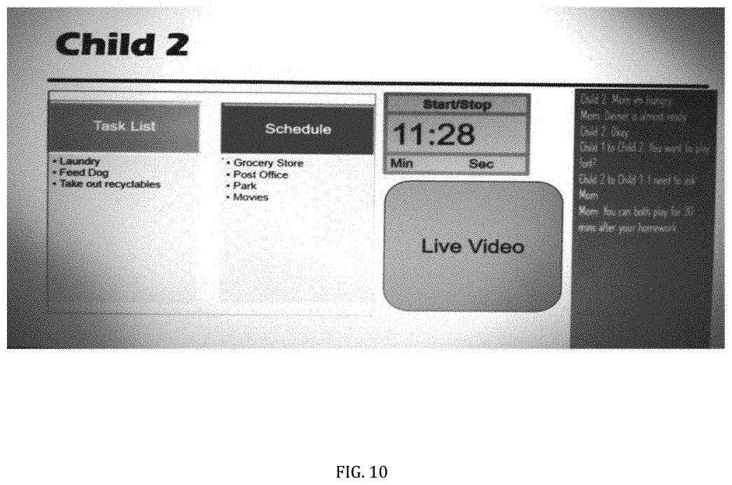

Reference is next made to FIG. 10 is an alternate child tablet interface in accordance with embodiments of the disclosure.

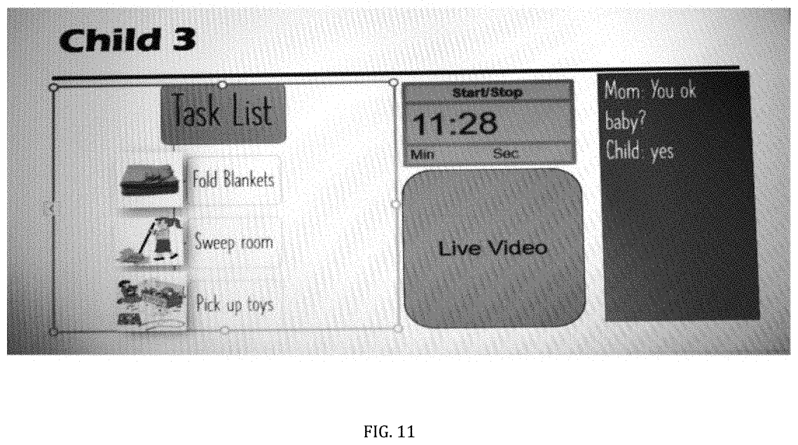

Reference is now made to FIG. 11 is a child tablet pictorial interface in accordance with embodiments of the disclosure.

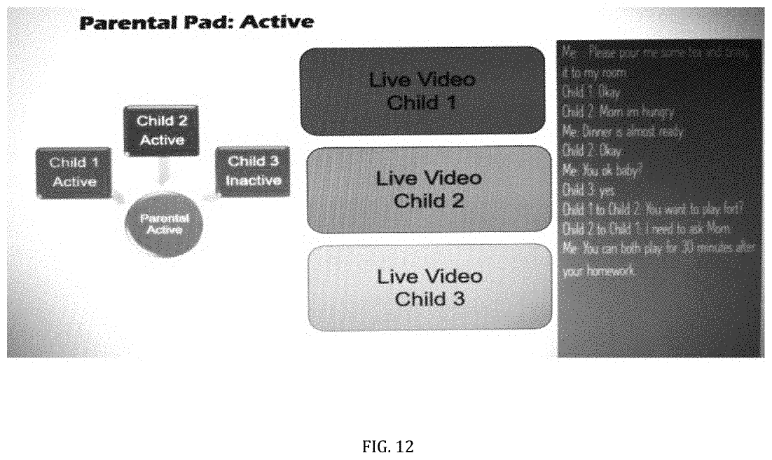

Reference is lastly made to FIG. 12 is a parent tablet interface in accordance with embodiments of the disclosure.

In brief, as described herein the device provides for a novel, effective and efficient tablet based task management system.

The disclosed systems and methods are generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention.

Terms such as “a”, “an”, and “the” are not intended to refer to only a singular entity, but include the general class of which a specific example may be used for illustration. The terminology herein is used to describe specific embodiments of the invention, but their usage does not delimit the disclosed systems or methods, except as may be outlined in the claims.

Any embodiments comprising a one component or a multi-component system having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific systems and methods described herein. Such equivalents are considered to be within the scope of this invention and are covered by the claims.

All publications, references, patents, and patent applications mentioned in the specification are indicative of the level of those skilled in the art to which this invention pertains. All publications, references, patents, and patent application are herein incorporated by reference to the same extent as if each individual publication, reference, patent, or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The systems and/or methods disclosed and claimed herein can be made and executed without undue experimentation in light of the present disclosure. While the systems and methods of this invention have been described in terms of preferred embodiments, it will be apparent to those skilled in the art that variations may be applied to the systems and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

1. The tablet based task management system as disclosed herein.
